(19) United States
(12) Patent Application Publication
(10) Pub. No.: US 2019/0392081 A1
(43) Pub. Date: Dec. 26, 2019

(54) SYSTEM AND METHOD FOR SEARCHING INFORMATION ACROSS MULTIPLE DATA SOURCES

(71) Applicant: David Ligon, Chandler, AZ (US)

(72) Inventor: David Ligon, Chandler, AZ (US)

(21) Appl. No.: 16/015,035

(22) Filed: Jun. 21, 2018

(51) Int. Cl. G06F 17/30; G06F 3/0482

(52) U.S. Cl. CPC G06F 17/30867; G06F 17/30887; G06F 2216/03; G06F 3/0482; G06F 17/30539

(57) ABSTRACT

A system and method are provided for constructing query links which produces executable predefined hypertext links useful for mining data. Simple inputs (such as search terms) are converted into executable hypertext links. Searches can be automatically executed from the touch of a button or the like across multiple search engines and publicly accessible databases, from a centralized master console. The generated output code allows exhaustive internet searches to be performed in a remote automated manner quickly and easily through massive amounts of data with a high degree of accuracy. Furthermore, a complete end-to-end data mining solution is disclosed that includes processes that occur prior to construction of the query links as well as those that occur afterwards, including employing artificial intelligence techniques so as to return more meaningful and relevant data.

### BACKGROUND

### 1. Field

The present disclosure relates to information searching, and more particularly, to a system and method for generating high volume queries across multiple sources.

### 2. Description of the Related Art

A recent article in a prominent medical journal evaluated the use of Internet search engines for performing medical research. The article found that Internet search engines could be useful in medical research, and endorsed their usage by the medical research community. However, the problem with the current search tools available for performing large-scale data mining from Internet sources is that users must manually enter search criteria from the respective search interfaces, which is time and labor intensive, making many research tasks impractical or unfeasible using conventional approaches.

As an example, suppose one wanted to research the topic of cancer survivorship and clinical trials for each of 200 cancer types across 200 countries/regions from four sources (including three search engines and one open searchable database). The amount of queries, or individual searches required in this case would be quite staggering (i.e., 2×200×200×4 or 320,000 queries). If each search manually takes on average of 10 seconds to access the respective interface and type in search criteria, then the time required to perform this manually would be 3,200,000 seconds or 37 calendar days.

The closest functional alternative on the market today may be a “meta-search engine,” such as Dogpile, which can search multiple search engines at once but falls far short as a viable solution. Meta-search engines require users to manually enter text search criteria, and do not allow choice of search engines to be included in the query. Nor do they return results in schema native to each search interface queried. Furthermore, such existing meta-search engines only provide a subset of data that was found in the search, and lack transparency of operation. That is, it is not clear from the meta-search exactly how the search was performed and the results filtered. As a result, not many people use meta-search engines, and instead favor the functionality and results offered directly by conventional search engines such as Google, Bing, Ask, etc.

### SUMMARY

A system and method are provided for constructing query links which produces executable predefined hypertext links useful for mining data. Simple inputs (such as search terms) are converted into executable hypertext links. Searches can be automatically executed from the touch of a button or the like across multiple search engines and publicly accessible databases, from a centralized master console. The generated output code allows exhaustive internet searches to be performed in a remote automated manner quickly and easily through massive amounts of data with a high degree of accuracy. Furthermore, a complete end-to-end data mining solution is disclosed that includes processes that occur prior to construction of the query links as well as those that occur afterwards, including employing artificial intelligence techniques so as to return more meaningful and relevant data.

### BRIEF DESCRIPTION OF THE DRAWINGS

FIG. 1 illustrates the input, processing and output flow of a process for constructing query links, according to an embodiment.

FIG. 2 is a diagram showing processes useable before and after the process for constructing query links, according to an embodiment.

FIG. 3 illustrates the input, process and output flow of the Data Mining Dashboard, according to an embodiment.

FIG. 4 is a diagram of an example Data Mining Dashboard useable in conjunction with the present invention, according to an embodiment.

FIG. 5 is a diagram of an example Data Mining XLoader component useable in conjunction with the present invention, according to an embodiment.

FIG. 6 is a diagram of an example Data Mining Xtractor component useable in conjunction with the present invention, according to an embodiment.

FIG. 7 is a diagram showing a system for searching information across multiple data sources, according to an embodiment.

### DETAILED DESCRIPTION

In the disclosure, exemplary processes for performing various aspects of the present invention are disclosed. It is to be understood that by executing computer program code on a computer system the processes disclosed herein can be performed. The program code can be written in a variety of suitable programming languages, such as C, C++, C#, Visual Basic, and Java. It is also to be understood that the software of the invention can, where appropriate, further include various Web-based applications that can be written in HTML, PHP, Javascript, jQuery, etc., accessible by the clients using a suitable browser 145 (e.g., Internet Explorer, Microsoft Edge, Mozilla Firefox, Google Chrome, Safari, Opera) or as an application running on a suitable mobile device (e.g., an iOS or Android “app”).

Overview of the URAQMD Process and its Uses and Applications

The mnemonic acronym of URAQMD was selected to provide a meaningful way to remember the basic components of the process and serves as a checklist for defining its unique set of characteristics in context of real-world applications:

Universal

The URAQMD process applies universally across browser platforms, for online web-based application as well as and across search engines and searchable open databases.

Remote

Searches can be conducted remotely to third-party search engines and databases, without the user having to actually go to those search interfaces, enter their search text and click on search. Query values can be passed remotely to multiple data mining sources from a single centralized master console or dashboard, which make it possible to return the same dynamic results remotely through hypertext protocol code generated by the URAQMD process.

Automated

Data mining is performed in an automated fashion, without the need for users to type anything into a search field.

Query

Pre-defined executable search query code (i.e., http and https hyperlinks) is generated by the URAQMD Process as output.

Mining Data

Process of searching data to locate a particular target, where large volumes of data must be accessed and sorted through to extract a relatively small amount of information.

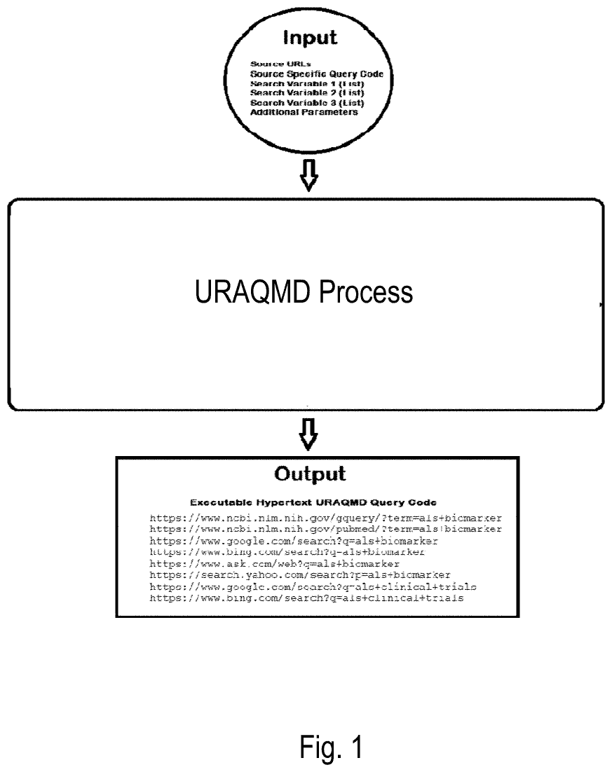

The diagram in FIG. 1 illustrates the input, processing and output flow of the URAQMD Process.

URAQMD Process:
[source(n)-url] [source(n)-specific-query-code] [search-variable1(x)] [+] [search-variable2(x)] [+] [search-variable3(x)] . . . [additional-parameters]

The applied theory for the URAQMD process states that when valid values are supplied for the symbolic elements, a line of code will be generated, which when executed will return the desired search results data without users having to manually load the search source interfaces or type in any text to pass the values and return results. Two real-world uses include 1) Data Mining Dashboard and 2) Upstream/Downstream Data Mining Processes which are described in detail below.

Uses and Applications

1. Data Mining Dashboard

A “Data Mining Dashboard” is an Internet-based or mobile device application (i.e., app) which utilizes the URAQMD Process as the enabling technology used to facilitate a master-console type of graphical user interface (GUI) which offers users an all “point-and-click” approach (using predefined search queries generated by the process linked to icons or text) for mining specific data from publicly available sources, such as search engines and open databases quickly and easily with great accuracy.

A notable advantage offered by the Data Mining Dashboard is automating the manual labor-intensive and time-consuming process of loading up other search engines and databases in a web browser or mobile device, then entering the same set of strings manually across multiple sessions. The time-savings realized by this approach when dealing with large amounts of data en masse is significant.

For example, when surveying clinical trials for breast cancer across 200 countries and geographic regions, it could take weeks just to mechanically retrieve the first round of search results for analysis. The Data Mining Dashboard approach allows data from such queries to be issued and returned easily by one user within an hour or two, rather than weeks or months.

In some cases, users may not know the best source to query or the optimal search criteria to enter to achieve their desired results. Optimized queries to data mining sources for the desired data can be selected beforehand, based on specifications, in an upstream process which feeds data to the process, so the user can retrieve expert results without having to be an expert in search methodology.

2. Upstream and Downstream Data Mining Processes

As used herein, Upstream and Downstream data mining processes are processes which occur prior to use of the URAQMD process, and after use of the URAQMD process, respectively.

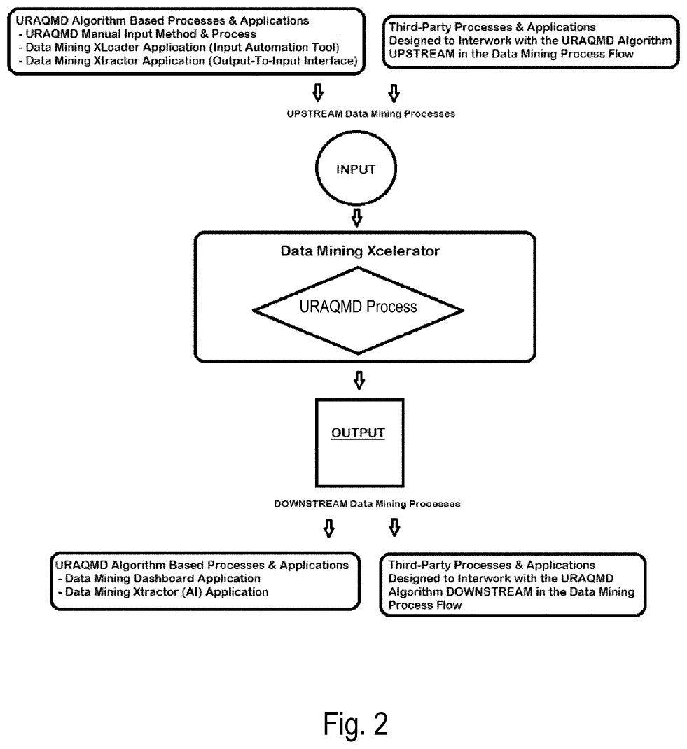

The process flow diagram (FIG. 2) illustrate Upstream and Downstream data mining processes and applications of the URAQMD process.

An example of an Upstream data mining application would be an HTML GUI front-end which automates gathering input values for the URAQMD Process through online form fields or some other means. It also includes any applications that automates any part of the URAQMD Process that is not currently automated in its design. For example, a more efficient way to automate the substitution of values for symbolic variables, than a manual method, would fall under an Upstream technique, as used herein.

A Downstream data mining process is one that uses the output from the URAQMD Process for additional data-mining-oriented processes. For example, results of biomarker queries could be put through another backend process downstream, e.g., utilizing artificial intelligence (AI), which parses the search results into URL links to relevant documents which can then be scanned further for text strings or phrases such as X “is a biomarker for” Y, for the purpose of building a biomarker-by-disease list. An automated AI utility which executes the predefined query links, and performs a surface level and sub-surface level scanning of search results to intelligently extract data from the output pages is a notable design concept behind such a Downstream process.

The URAQMD Process is well suited to areas of data mining beyond cancer research. For example, the URAQMD process could be employed to data mine biomarkers and clinical trials for other diseases such as ALS, Alzheimer's and diabetes. An example of this particular use of the URAQMD process is featured later in this disclosure to illustrate other real-world uses and applications of the technology.

Technical Specifications for the URAQMD Process

Technical Specifications for the URAQMD Process are provided below.

URAQMD Process
[source(n)-url] [source(n)-specific-query-code] [search-variable1(x)] [+] [search-variable2(x)] [+] [search-variable3(x)] . . . [additional-parameters]

Where:
“source(n)-url”
Source URL is the initial building block component in the process, representing the base URL for the search engine or database website to be data mined. It typically begins with “https://” or “http://” followed by the domain name as in “https://www.google.com/” or “https://www.ncbi.nlm.nih.gov/but may contain a subfolder as is the case with PubMed Database https://www.ncbi.nlm.nih.gov/pubmed/. An increment number “n” is provided in the symbolic as a unique identifier to distinguish multiple data sources in the code, and to pair up with the appropriate “source(n)-specific-query-code” value.
“source(n)-specific-query-code”
After the Source URL, a few characters of code are required to execute the search, which are specific to their corresponding sources. For example, both Google and Bing search engines accept the same parameter of “search?q=” as a valid value for this symbolic variable. An increment number “(n)” is provided in the symbolic variable as a unique identifier to distinguish multiple data sources in the code, and to pair up with the appropriate “source(n)-url” value.
“search-variable1(x)”
Search Variable 1 is required at minimum to provide at least one text string to data mine from the specified source. An “(x)” is used to denote an array of values which can be input to the URAQMD process through this symbolic. One such example is when “search-variable1” is defined as “cancertype(x)” it can accommodate an array or list of input values to simplify the coding structure, where it would appear as cancertype(x)=(“appendiceal+cancer”,“bone+cancer”,“brain+cancer”,“b reast+cancer” . . . etc.).
“+”
The Plus Sign character is used as the AND logical connector between multiple Search-Variables.
“search-variable2(x)”
Search Variable 2 text string input is not a requirement unless the query needs the additional filtering logic. Typically it is used. For example, it is helpful to search multiple sources for “breast+cancer” but even more helpful when you can further refine that data, such as to locate “biomarkers” or “clinical+trials” for “breast+cancer”. Structurally, one can think of Search Variable 1 as the topic and Search Variable 2 as the subtopic. An “(x)” is used to denote an array of values which can be input to the URAQMD process through this symbolic. For example, when “search-variable2” is defined as “subtopic(x)” it can accommodate an array or list of input values such as subtopic(x)=(“biomarker”,“clinical+trials” . . . etc.).
“search-variable3(x)”
Search Variable 3 text string input is not a requirement unless the query needs the additional filtering logic. Although the process can accommodate three or more search-variables, keep in mind that the more restrictive the filtering the more you risk returning zero results. It is necessary to include the third Search Variable in cases for example where you want to survey “breast+cancer” “clinical+trials” by “countrytype(x)”. In this example, “search-variable3” is defined as “countrytype(x)” where countrytype(x)=(“afghanistan”, “albania”, “algeria”, “andorra”, “angola” . . . etc.). An “(x)” is also used here to denote an array of values which can be input to the URAQMD process through this symbolic.
“additional-parameters”
Symbolic reserved for cases where a bit of code must be appended to the query string generated by the process in order to accomplish the result from a specific source. This is a requirement in some cases to specify News searches, specify Sort order for query output and/or Time Range searches and other parameters. Here are two common examples:

Google News queries require this symbolic to be defined as “additional-parameters”=“&tbm=nws” as in the following query code: https://www.google.com/search?q=cancer+cures&tbm=nws

Google queries filtered for time range (e.g. results from the Past Year) require this symbolic to be defined as “additional-parameters”=“&tbs=qdr:y” as in the following query code:

https://www.google.com/search?q=cancer+cures&tbs=qdr:y

After understanding how the URAQMD process is structured, the next step is to define values for the symbolic variables, and substitute input values for symbolics and arrays in code.

Method for Defining and Substituting Symbolic Variables in the URAQMD Process to Generate Code

A. Overview

This section introduces a method for using the URAQMD process to generate code, through an assignment of values to variables based on input specifications, then substituting symbolics in the process to form the output code. A case study example is also provided to illustrate how the URAQMD process may be used in a real-world data mining scenario.

Case Study (Example 1): Using the URAQMD Process to Generate Predefined Query Code

SPEC01: Data mine biomarkers and clinical trials for ALS, Alzheimer's and diabetes from PubMed, Google, Bing, Ask and Yahoo.

Step 1. Begin by defining input values for symbolic variables and logical arrays, based on the specifications from SPEC01, in the Assigned Symbolic Values table, which will be used by the URAQMD process to generate the predefined query code:

URAQMD Process (Compressed Format):

source(n)-urlSource(n)-specific-query-codeSearch-variable1(x)+Search-variable2(x)

Assigned Symbolic Values:

source1-url=“https://www.ncbi.nlm.nih.gov/pubmed/”
source2-url=“https://www.google.com/”
source3-url=“https://www.bing.com/”
sourced-url=“https://www.ask.com/”
source5-url=“https://search.yahoo.com/”
source1-specific-query-code=“?term=”
source2-specific-query-code=“search?q=”
source3-specific-query-code=“search?q=”
source4-specific-query-code=“web?q=”
source5-specific-query-code=“search?p=”
search-variable1=“diseasetype(“als”, “alzheimers”, “diabetes”)”
search-variable2=“subtopictype(“biomarker”, “clinical+trials”)”

Step 2. After assigning values to symbolic variables and logical arrays in the Assigned Symbolic Values table based on the specified input, the next step is to prepare the URAQMD Process to meet the scope of the SPEC01 data mining requirements, before actually substituting values for the symbolic variables. To do this, begin by identifying the total number of sources (5) and use that to form the first logical block of symbolic code to perform the task. This block of symbolic code is referred to as a “Source Block” (or Source-Block):

Source-Block

source1-urlSource1-specific-query-codeSearch-variable1(x)+Search-variable2(x)
source2-urlSource2-specific-query-codeSearch-variable1(x)+Search-variable2(x)
source3-urlSource3-specific-query-codeSearch-variable1(x)+Search-variable2(x)
source4-urlSource4-specific-query-codeSearch-variable1(x)+Search-variable2(x)
source5-urlSource5-specific-query-codeSearch-variable1(x)+Search-variable2(x)

Next, we'll calculate the number of Source Blocks of code needed to meet the specifications. Regardless of how many sources are in the Source Block you will need to make one complete pass for each item in the Search-Variable1 Array (3) multiplied by the number of items in Search-Variable2 Array (2) which calls for 6 Source Blocks total. The only symbolic values we are substituting in the code before copying the “Source Block” 6 times is to substitute the Search-Variable Array Names with their Descriptive Names followed a sequence number, as shown below:

source1-urlSource1-specific-query-codeDiseasetype1+Subtopictype1
source2-urlSource2-specific-query-codeDiseasetype1+Subtopictype1
source3-urlSource3-specific-query-codeDiseasetype1+Subtopictype1
source4-urlSource4-specific-query-codeDiseasetype1+Subtopictype1
source5-urlSource5-specific-query-codeDiseasetype1+Subtopictype1
source1-urlSource1-specific-query-codeDiseasetype1+Subtopictype2
source2-urlSource2-specific-query-codeDiseasetype1+Subtopictype2
source3-urlSource3-specific-query-codeDiseasetype1+Subtopictype2
source4-urlSource4-specific-query-codeDiseasetype1+Subtopictype2
source5-urlSource5-specific-query-codeDiseasetype1+Subtopictype2
source1-urlSource1-specific-query-codeDiseasetype2+Subtopictype1
source2-urlSource2-specific-query-codeDiseasetype2+Subtopictype1
source3-urlSource3-specific-query-codeDiseasetype2+Subtopictype1
source4-urlSource4-specific-query-codeDiseasetype2+Subtopictype1
source5-urlSource5-specific-query-codeDiseasetype2+Subtopictype1
source1-urlSource1-specific-query-codeDiseasetype2+Subtopictype2
source2-urlSource2-specific-query-codeDiseasetype2+Subtopictype2
source3-urlSource3-specific-query-codeDiseasetype2+Subtopictype2
source4-urlSource4-specific-query-codeDiseasetype2+Subtopictype2
source5-urlSource5-specific-query-codeDiseasetype2+Subtopictype2
source1-urlSource1-specific-query-codeDiseasetype3+Subtopictype1
source2-urlSource2-specific-query-codeDiseasetype3+Subtopictype1
source3-urlSource3-specific-query-codeDiseasetype3+Subtopictype1
source4-urlSource4-specific-query-codeDiseasetype3+Subtopictype1
source5-urlSource5-specific-query-codeDiseasetype3+Subtopictype1
source1-urlSource1-specific-query-codeDiseasetype3+Subtopictype2
source2-urlSource2-specific-query-codeDiseasetype3+Subtopictype2
source3-urlSource3-specific-query-codeDiseasetype3+Subtopictype2
source4-urlSource4-specific-query-codeDiseasetype3+Subtopictype2
source5-urlSource5-specific-query-codeDiseasetype3+Subtopictype2

Step 3. After preparing the Source Blocks to receive values for the symbolic variables, then execute a search and replace of symbolics in the Source Blocks above, using values specified in the Assigned Symbolic Values table. A total of 15 symbolic values will be searched and replaced in the Source Blocks:

Assigned Symbolic Values:

source1-url=“https://www.ncbi.nlm.nih.gov/pubmed/”
source2-url=“https://www.google.com/”
source3-url=“https://www.bing.com/”
source4-url=“https://www.ask.com/”
source5-url=“https://search.yahoo.com/”
source1-specific-query-code=“?term=”
source2-specific-query-code=“search?q=”
source3-specific-query-code=“search?q=”
source4-specific-query-code=“web?q=”
source5-specific-query-code=“search?p=”
diseasetype1=“als”
diseasetype2=“alzheimers”
diseasetype3=“diabetes”
subtopictype1=“biomarker”
subtopictype2=“clinical+trials”

Here is the resulting output from the URAQMD process which generated this predefined query code to meet the research needs of the specification:

https://www.ncbi.nlm.nih.gov/pubmed/?term=als+biomarker
https://www.google.com/search?q=als+biomarker
https://www.bing.com/search?q=als+biomarker
https://www.ask.com/web?q=als+biomarker
https://search.yahoo.com/search?p=als+biomarker
https://www.ncbi.nlm.nih.gov/pubmed/?term=als+clinical+trials
https://www.google.com/search?q=als+clinical+trials
https://www.bing.com/search?q=als+clinical+trials
https://www.ask.com/web?q=als+clinical+trials
https://search.yahoo.com/search?p=als+clinical+trials
https://www.ncbi.nlm.nih.gov/pubmed/?term=alzheimers+biomarker
https://www.google.com/search?q=alzheimers+biomarker
https://www.bing.com/search?q=alzheimers+biomarker
https://www.ask.com/web?q=alzheimers+biomarker
https://search.yahoo.com/search?p=alzheimers+biomarker
https://www.ncbi.nlm.nih.gov/pubmed/?term=alzheimers+clinical+trials
https://www.google.com/search?q=alzheimers+clinical+trials
https://www.bing.com/search?q=alzheimers+clinical+trials
https://www.ask.com/web?q=alzheimers+clinical+trials
https://search.yahoo.com/search?p=alzheimers+clinical+trials
https://www.ncbi.nlm.nih.gov/pubmed/?term=diabetes+biomarker
https://www.google.com/search?q=diabetes+biomarker
https://www.bing.com/search?q=diabetes+biomarker
https://www.ask.com/web?q=diabetes+biomarker
https://search.yahoo.com/search?p=diabetes+biomarker
https://www.ncbi.nlm.nih.gov/pubmed/?term=diabetes+clinical+trials
https://www.google.com/search?q=diabetes+clinical+trials
https://www.bing.com/search?q=diabetes+clinical+trials
https://www.ask.com/web?q=diabetes+clinical+trials
https://search.yahoo.com/search?p=diabetes+clinical+trials

These Universal Remote Automated Queries for Mining Data are now ready for use in a Downstream data mining process, such as the Data Mining Dashboard or the Data Mining Xtractor.

Data Mining Dashboard

A. Design Overview

A Data Mining Dashboard is an Internet-based or mobile device application (i.e., app) which utilizes the URAQMD process as the enabling technology used to power a master-console type of Graphic User Interface (GUI) which offers users an all “point-and-click” approach (using predefined search queries generated by the process linked to icons or text) for mining specific data from publicly available sources, such as search engines and open databases on a vast scale quickly and easily with great accuracy.

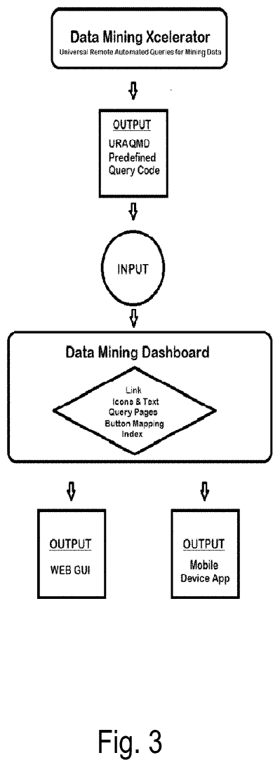

The process flow diagram shown in FIG. 3 illustrates the input, process and output flow of the Data Mining Dashboard. Two case studies, in the form of a step-by-step process, are presented in this section to illustrate how output from the URAQMD process can be used to create both simple and complex Data Mining Dashboard applications.

Case Study (Example 2): Using the URAQMD Process to Create a Data Mining Dashboard Application

SPEC02: Create a Data Mining Dashboard for a research team to data mine sources for proteins and enzymes expressed by neoplasms.

The intent of this example is to show how the URAQMD process can be used in a Data Mining Dashboard application to facilitate Data Mining for professional research teams (from an actual example in July 2017 for the CICS Sonora Cancer Research Team).

Step 1. To meet the requirements of SPEC02, the process began with identifying the sources to be data mined for this type of information (major search engines and open medical databases). Seven source targets were identified, along with their corresponding Symbolic values for “Source(n)-url”:

### 1. NIH Top Level Multi Database

[Source(1)url=“https://www.ncbi.nlm.nih.gov/gquery/”]

### 2. NIH Protein Database

[Source(2)-url=“https://www.ncbi.nlm.nih.gov/protein/”]

### 3. NIH PubMed Database

[Source(3)-url=“https://www.ncbi.nlm.nih.gov/pubmed/”]

### 4. Google Search Engine

[Source(4)-url=“https://www.google.com/”]

### 5. Bing Search Engine

[Source(5)-url=“https://www.bing.com/”]

### 6. Ask Search Engine

[Source(6)-url=“https://www.ask.com/”]

### 7. Yahoo Search Engine

[Source(7)-url=“https://search.yahoo.com/”

Step 2. After identifying sources and their corresponding “Source(n)-url” values, identify values for “Source(n)-Specific-Query-Code” corresponding to each of the above sources:

### 1. NIH Top Level Multi Database [Source(1)-Specific-Query-Code=“?term=”]

### 2. NIH Protein Database [Source(2)-Specific-Query-Code=“?term=”]

### 3. NIH PubMed Database [Source(3)-Specific-Query-Code=“?term=”]

### 4. Google Search Engine [Source(4)-Specific-Query-Code=“search?q=”]

### 5. Bing Search Engine [Source(5)-Specific-Query-Code=“search?q=”]

### 6. Ask Search Engine [Source(6)-Specific-Query-Code=“web?q=”]

### 7. Yahoo Search Engine [Source(7)-Specific-Query-Code=“search?p”]

Step 3. Determine values for search variables Search-Variable1 (x) and Search-Variable2(x) to meet the requirements of SPEC02, by selecting terms which optimize the chances of successful data mining results. In this case, we are looking for enzymes and proteins expressed by neoplasms. The values for these symbolics are assigned as follows:

### Search-Variable1(x)=“neoplasia”

SearchVariable2(x)=“subtopictype(“protein+expression”, “enzyme+expression”)”

Step 4. Calculate how many lines of code will be in the Source Block. For each Search-Variable1 (x) one complete pass will need to be made through all seven sources. Another pass through all seven sources will be required for the second search variable “Search-Variable2(x).

The formula is (Number of Sources)×(Number of Items in the Logic Array for Search-Variable1)×(Number of Items in the Logic Array for Search-Variable2):

### Number of Sources=7

### Number of Items in Search-Variable1(x) Logic Array=1

### Number of Items in Search-Variable2(x) Logic Array=2

Thus, based on the resulting calculation, we will need a total of 14 lines, comprised of 2 Source Blocks with 7 lines each:
7×1×2+14

Step 5. Copy the URAQMD process template down in preparation to substitute values for the symbolics in the code.

URAQMD Process (Full):
[source(n)-url] [source(n)-specific-query-code] [search-variable1(x)] [+] [search-variable2(x)] [+] [search-variable3(x)] . . . [additional-parameters]

URAQMD Process (Compressed):
source(n)-urlSource(n)-specific-query-codeSearch-variable1(x)+Search-variable2(x)

Source-Block-1

source(1)-urlSource(1)-specific-query-codeSearch-variable1(x)+Search-variable2(x)
source(2)-urlSource(2)-specific-query-codeSearch-variable1(x)+Search-variable2(x)
source(3)-urlSource(3)-specific-query-codeSearch-variable1(x)+Search-variable2(x)
source(4)-urlSource(4)-specific-query-codeSearch-variable1(x)+Search-variable2(x)
source(5)-urlSource(5)-specific-query-codeSearch-variable1(x)+Search-variable2(x)
source(6)-urlSource(6)-specific-query-codeSearch-variable1(x)+Search-variable2(x)
source(7)-urlSource(7)-specific-query-codeSearch-variable1(x)+Search-variable2(x)

Source-Block-2

source(1)-urlSource(1)-specific-query-codeSearch-variable1(x)+Search-variable2(x)
source(2)-urlSource(2)-specific-query-codeSearch-variable1(x)+Search-variable2(x)
source(3)-urlSource(3)-specific-query-codeSearch-variable1(x)+Search-variable2(x)
source(4)-urlSource(4)-specific-query-codeSearch-variable1(x)+Search-variable2(x)
source(5)-urlSource(5)-specific-query-codeSearch-variable1(x)+Search-variable2(x)
source(6)-urlSource(6)-specific-query-codeSearch-variable1(x)+Search-variable2(x)
source(7)-urlSource(7)-specific-query-codeSearch-variable1(x)+Search-variable2(x)

Step 6. Substitute symbolics with assigned values in both Source Blocks using the following definitions:

### Assigned Symbolic Values:

source1-url=“https://www.ncbi.nlm.nih.gov/gquery/”
source2-url=“https://www.ncbi.nlm.nih.gov/protein/”
source3-url=“https://www.ncbi.nlm.nih.gov/pubmed/”
source4-url=“https://www.google.com/”
source5-url=“https://www.bing.com/”
source6-url=“https://www.ask.com/”
source7-url=“https://search.yahoo.com/”
source1-specific-query-code=“?term=”
source2-specific-query-code=“?term=”
source3-specific-query-code=“?term=”
source4-specific-query-code=“search?q=”
source5-specific-query-code=“search?q=”
source6-specific-query-code=“web?q=”
source7-specific-query-code=“search?p=”
search-variable1(x)=“neoplasia”
search-variable2(x)=“subtopictype(“protein+expression”, “enzyme+expression”)”

The resulting output shown below is ready to be loaded into the Data Mining Dashboard as links to icons and descriptive text:

### Source-Block-1

https://www.ncbi.nlm.nih.gov/gquery/?term=neoplasia+protein+expression
https://www.ncbi.nlm.nih.gov/protein/?term=neoplasia+protein+expression
https://www.ncbi.nlm.nih.gov/pubmed/?term=neoplasia+protein+expression
https://www.google.com/search?q=neoplasia+protein+expression
https://www.bing.com/search?q=neoplasia+protein+expression
https://www.ask.com/web?q=neoplasia+protein+expression
https://search.yahoo.com/search?p=neoplasia+protein+expression

Source-Block-2

https://www.ncbi.nlm.nih.gov/gquery/?term=neoplasia+enzyme+expression
https://www.ncbi.nlm.nih.gov/protein/?term=neoplasia+enzyme+expression
https://www.ncbi.nlm.nih.gov/pubmed/?term=neoplasia+enzyme+expression
https://www.google.com/search?q=neoplasia+enzyme+expression
https://www.bing.com/search?q=neoplasia+enzyme+expression
https://www.ask.com/web?q=neoplasia+enzyme+expression
https://search.yahoo.com/search?p=neoplasia+enzyme+expression

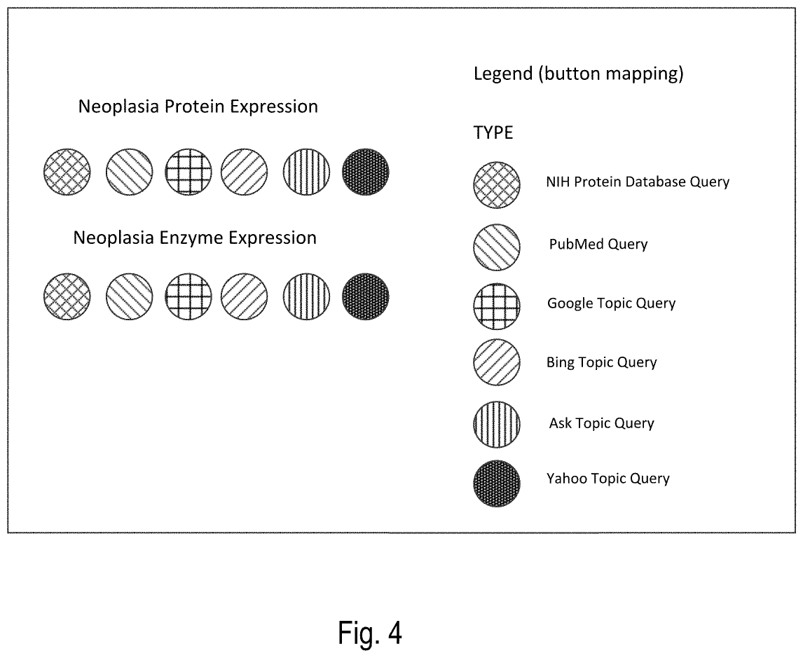

An example of the completed real-world implementation of this Data Mining Dashboard application is illustrated in FIG. 4.

The method illustrated above for using the URAQMD process to create a simple Data Mining Dashboard application is now complete. The next example furthers this concept by using the URAQMD process to create a complex Data Mining Dashboard application, used in another real-world implementation.

Case Study (Example 3): Using the URAQMD Process to Create a Complex Data Mining Dashboard Application

SPEC03: Input 1,000 cancer types and subtypes into the URAQMD process as Search-Variable1 (x), and create 13 predefined automated queries per type, for a total of 13,000 links that will be used to create the Dashboard application. Use whatever sources and topics seem of most value in order to create specifications for the 13 requested links in each Source Block.

Step 1. Sources and topics are identified, then entered into a Query Button Specifications Table for reference:

### 1. Text: Cancertype Query NIH Multi-Database

### 2. Icon: Cancertype Marker Query NIH PubMed Database

### 3. Icon: Cancertype Marker Query Google Search Engine

### 4. Icon: Cancertype Marker Query Bing Search Engine

### 5. Icon: Cancertype Biomarker Query Ask Search Engine

### 6. Icon: Cancertype Clinical Trials Query Google Search Engine

### 7. Icon: Cancertype Clinical Trials Query Bing Search Engine

### 8. Icon: Cancertype Clinical Trials Query Yahoo Search Engine

### 9. Icon: Cancertype Query Google Search Engine

### 10. Icon: Cancertype Query Bing Search Engine

### 11. Icon: Cancertype Query Yahoo Search Engine

### 12. Icon: Cancertype News Query Google Search Engine

### 13. Icon: Cancertype News Query Bing Search Engine

Step 2. The URAQMD Process was then used to set up a 13 line Source-Block based on the above Specifications. Prepare a concatenated version of the URAQMD Process as shown below, with qualified Source(n) values.

URAQMD Process:
[Source(n)-url] [Source(n)-specific-query-code] [search-variable1(cancertype)] [+] [search-variable2(subtopictype)] [Source12-additional-parameters=“&tbm=nws”]
   source1-urlSource1-specific-query-codeSearch-Variable1(cancertype)
   source2-urlSource2-specific-query-codeSearch-Variable1(cancertype)+Search-Variable2(subtopictype1)
   source3-urlSource3-specific-query-codeSearch-Variable1(cancertype)+Search-Variable2(subtopictype1)
   source4-urlSource4-specific-query-codeSearch-Variable1(cancertype)+Search-Variable2(subtopictype1)
   source5-urlSource5-specific-query-codeSearch-Variable1(cancertype)+Search-Variable2(subtopictype1)
   source6-urlSource6-specific-query-codeSearch-Variable1(cancertype)+Search-Variable2(subtopictype2)
   source7-urlSource7-specific-query-codeSearch-Variable1(cancertype)+Search-Variable2(subtopictype2)
   source8-urlSource8-specific-query-codeSearch-Variable1(cancertype)+Search-Variable2(subtopictype2)
   source9-urlSource9-specific-query-codeSearch-Variable1(cancertype)
   source10-urlSource10-specific-query-codeSearch-Variable1(cancertype) source11-urlSource11-specific-query-codeSearch-Variable1(cancertype)
   source12-urlSource12-specific-query-codeSearch-Variable1(cancertype)Source12-additional-parameters
   source13-urlSource13-specific-query-codeSearch-Variable1(cancertype)

Assigned Symbolic Values:

source1-url=“https://www.ncbi.nlm.nih.gov/gquery/”
source2-url=“https://www.ncbi.nlm.nih.gov/pubmed/”
source3-url=“https://www.google.com”
source4-url=“https://www.bing.com/”
source5-url=“https://www.ask.com/”
source6-url=“https://www.google.com/”
source7-url=“https://www.bing.com/”
source8-url=“https://search.yahoo.com/”
source9-url=“https://www.google.com/”
source10-url=“https://www.bing.com/”
source11-url=“https://www.yahoo.com/”
source12-url=“https://www.google.com/”
source13-url=“https://www.bing.com/news/”
source1-specific-query-code=“?term=”
source2-specific-query-code=“?term=”
source3-specific-query-code=“search?q=”
source4-specific-query-code=“search?q=”
source5-specific-query-code=“web?q=”
source6-specific-query-code=“search?q=”
source7-specific-query-code=“search?q=”
source8-specific-query-code=“search?p=”
source9-specific-query-code=“?term=”
source10-specific-query-code=“?term=”
source11-specific-query-code=“search?q=”
source12-specific-query-code=“search?q=”
source13-specific-query-code=“web?q=”
search-variable1(x)=“cancertype=(type1,type2,type3 . . . )”
search-variable2(x)=“subtopictype=(“marker”, “clinical+trials”)”
source12-additional-parameters=“&tbm=nws”

Step 3. Substitute Values for the Symbolics in the 13 line prepped version of the URAQMD Process, except for the cancertype(x) value, and this yields the “near fully-qualified” Source Block of code that will be pasted below each cancertype entry in the text file containing 1000 cancer types and subtypes.

Near-Fully-Qualified-Source-Block

https://www.ncbi.nlm.nih.gov/gquery/?term=cancertype
https://www.ncbi.nlm.nih.gov/pubmed/?term=marker+cancertype
https://www.google.com/search?q=marker+cancertype
https://www.bing.com/search?q=marker+cancertype
https://www.ask.com/web?q=marker+cancertype
https://www.google.com/search?q=cancertype+%22clinical+trials %22
https://www.bing.com/search?q=cancertype+%22clinical+trials %22
https://search.yahoo.com/search?p=cancertype+%22clinical+trials %22
https://www.google.com/search?q=cancertype
https://www.bing.com/search?q=cancertype
https://search.yahoo.com/search?p=cancertype
https://www.google.com/search?q=cancertype&tbm=nws
https://www.bing.com/news/search?q=cancertype

Step 4. Copy/Paste 1,000 occurrences of the above near-fully-qualified-source-block of code into the text file containing the 1,000 cancertypes, just below each cancertype.

Step 5. Search/Replace the remaining values for cancertypes in each of the 1000 near-fully-qualified-source-blocks in the text file, using the cancertype text value immediately above each source block, as the value to be used in that Source-Block for cancertype.

Step 6. Once all 1,000 source-blocks and their corresponding 13,000 links are ready for loading into the GUI, then update the Data Mining Dashboard Query Page GUI Template with their respective links. Prior to developing a GUI Template Design for an Enterprise Level Data Mining Dashboard, review the considerations below.

After reviewing Data Mining Dashboard GUI Considerations, button mapping, indexing and query pages per may be added into the GUI design.

Step 7. If your Dashboard design requires a separate legend or button Mapping Page from the Query Pages (recommended for larger implementations), then create that next based on the Query/Button Specifications listed in Step 1.

Step 8. If your Dashboard design requires a separate Index Page, or set of pages, apart from the Query Pages (recommended for larger implementations), create that next, using a Template.

Step 9. Create your Data Mining Dashboard GUI Template Query Pages based on the design specifications.

Step 10. The final step is to add each Query Link to the respective text boxes and icons on the Data Mining Dashboard Query Pages set up from the GUI Template.

Data Mining Dashboard GUI Design Considerations

Keep in mind the following considerations when designing a Data Mining Dashboard GUI application.

1. Physical Constraints vs. Number of Objects

The maximum number of objects which can be displayed on the Data Mining Dashboard is limited to the physical dimensions allowable by a website development tool and the practical limitations of the viewable area of a typical computer monitor screen, laptop or mobile device.

For one implementation of the Data Mining Dashboard, the dimensions allowed for 12 rows with 24 icons of 50 pixels each to be displayed, including a descriptive line of text above each row. Given the lengthy text title in some cases, smaller fonts were used, but ultimately limited the display on each page to two columns of 12 for a total of 24 Search-Variable1 Topics to be displayed with 13 Links each (12 icons, 1 text title).

To determine the total number of Query Pages at 24 entries per page required to accommodate 1,000 entries total, divide 1,000 by 24. The result, 41.6 pages would be required, rounded up to 42.

The number of Query Pages required for 1,024 entries (at 24 entries per page) is 42.6, so 43 Query Pages were created from a single GUI Template Query Page, with only values changing for the descriptive text, since icons in the template are in an unlinked state. Likewise, the 16 Index Pages were all created from a single Index GUI Template Page, and modified where appropriate. The unique custom center vertical scroll button design is meant to make it easier to navigate on mobile devices and was created specifically for Data Mining Dashboard.

2. Navigational Index and Button Mapping

Enterprise-level implementations of the Data Mining Dashboard will preferably require a navigational index and button mapping descriptions (for icons on the Query Pages).

3. Advanced Data Mining Dashboard Designs: Geospatial Navigation

The Data Mining Dashboard concept can be implemented in any number of new and unique ways, apart from the traditional rectangular set of clickable icons.

Geospatial navigation is a type of presentation and arrangement for a Data Mining Dashboard Index where the linked icons are displayed over a surface image of the earth, which has navigational elements to drill up, down or across to any region or country on the globe. Clicking the corresponding flag icon (or similar) will launch the Data Mining Dashboard Query Page for the respective Countrytype containing Data Mining Queries generated by defining Search-Variable3 as “countrytype” in the logical array for that variable in the URAQMD Process. For example, Search-Variable3(x)=countrytype(type1,type2,type3 . . . );

VIII. Data Mining XLoader

A. Design Overview

The problem to be solved, which drove the design concept for the Data Mining XLoader Add-on Component Tool, was the need to automatically feed in values from very large list arrays to the URAQMD process and then perform the substitution of symbolic variables with their corresponding values.

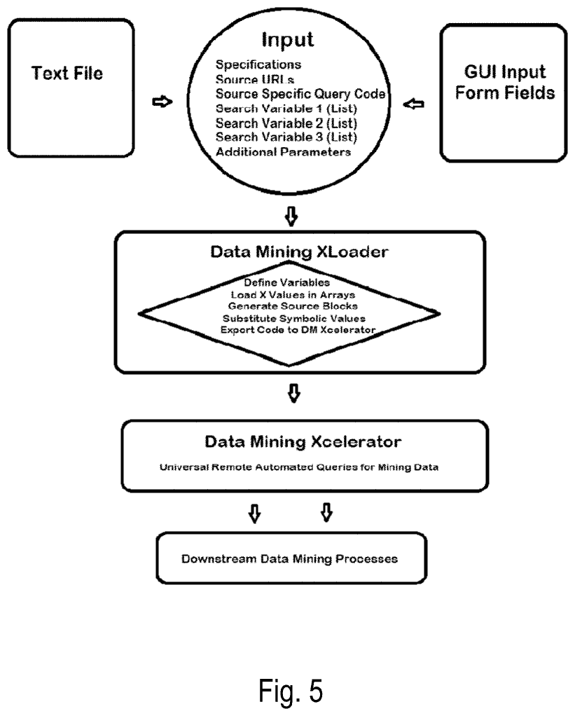

The process flow diagram in FIG. 5 illustrates the input, process and output flow of the Data Mining XLoader Add-on Component.

B. Input

Input for the Data Mining XLoader comprises text string values for symbolic variables needed by the URAQMD process to generate predefined query code output. The input may be provided via a human-based process such as by supplying a .TXT file, or via automated processes such as input fields in an HTML GUI interface, or some other means.

C. Process

After receiving input values, the Data Mining XLoader will process the input to the URAQMD Process, as follows:
Define the Variables
Load the X Values in the Variable Arrays
Generate the Source-Blocks
Substitute Values for Symbolics
Output the Code

D. Output

Output from the Data Mining XLoader process is comprised of fully qualified symbolic variables and arrays in the URAQMD process coding strings, where input values are automatically assigned and substituted in Source Blocks per specifications. The output can then be fed into the Data Mining Xcelerator for hand-off to Downstream Data Mining Processes such as Data Mining Dashboard applications or Data Mining Xtractor.

Data Mining Xtractor

Design Overview

The Data Mining Xtractor is the artificial intelligence (AI) component of the XcaliberDM Data Mining Tools Suite and forms the final part of an integrated end-to-end data mining solution. The artificial intelligence rules serve as the basis for the automated tool design to further refine the raw output from the Data Mining Xcelerator to deliver target objects at the end of the Data Mining Process Flow.

Raw output from the Data Mining Xcelerator will need to be analyzed and target objects extracted by inputting the data through an artificial intelligence refining process, known as the Data Mining Xtractor. It is the job of the Data Mining Xtractor to receive as input to its process the Data Mining Xcelerator output and produce a final output list of target objects.

The Data Mining Xtractor component is desirable to complete the end-to-end data mining solution in the design of the XcaliberDM Data Mining Tools Suite. Whereas the Data Mining Xcelerator produces pages which can be searched for specified target objects, it does not handle that portion of the task. For example, the Data Mining Xcelerator and the URAQMD process can return search results pages matching “biomarkers for diseasetype” but they do not actually deliver the target objects of biomarkers from those pages. The process of scanning output from Data Mining Xcelerator and then extracting the desired target objects, using AI rules, serves as the basis of its design.

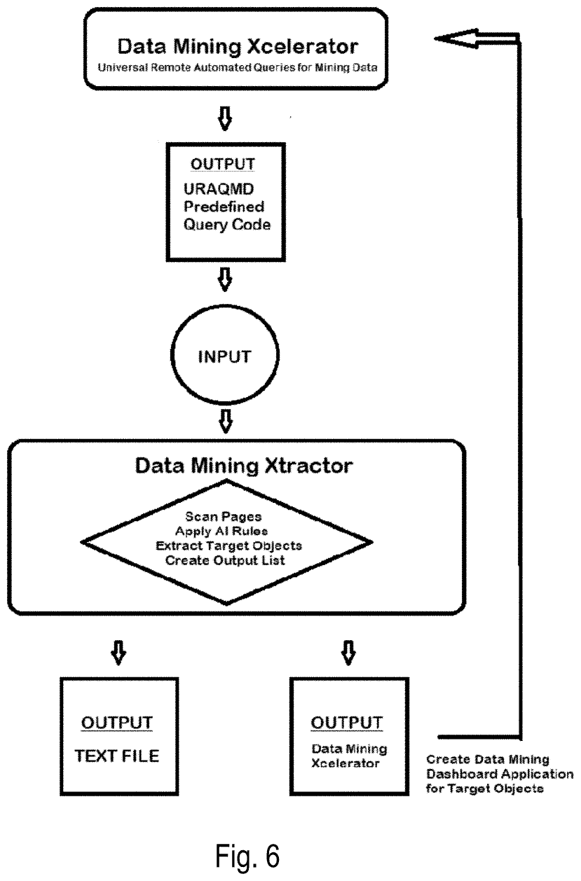

The Process Flow Diagram in FIG. 6 illustrates the input, process and output flow of the Data Mining Xtractor Add-on Component.

Input

The Data Mining Xcelerator output is fed as input into the Data Mining Xtractor process, either through an automated interface or through a Text file in the human-based manual process.

Process: AI Rules

Data Mining Xtractor executes hypertext search queries from Data Mining Xcelerator output to scan the surface pages of the search results, and where appropriate drill-down to sub-surface URLs and scan those pages, to locate target objects of the specified Data Mining operations by applying AI rules. Before an Artificial Intelligence component can be devised to perform the final refining of output from the Data Mining Xcelerator process to retrieve the final target data, a human being would need to analyze the data first, establish a set of rules which can be followed by both man and a Church-Turing compliant logic machine. Examples of such AI rules include: AI-RULE-01 (Exact Phrase or Equivalent), AI-RULE-02 (Triangulation Frequency), and AI-RULE-03 (Drill Down Criteria).

Output

Once the target objects have been extracted from the Data Mining Xtractor process, output can be to a text file (e.g., using CSV format), or those values can be used as input into the Data Mining Xcelerator to create predefined search queries for each biomarker linked to a Data Mining Dashboard application featuring information on biomarkers by disease type.

Case Study (Example 4:) Using the Process Output in a Downstream Data Mining Process

SPEC04: Use output from the URAQMD Process to mine data necessary for developing a list of biomarkers by disease type for ALS, Alzheimer's and diabetes.

The steps illustrated in the example below form the conceptual basis of the design for the artificial intelligence add-on component tool, called Data Mining Xtractor which is specifically designed to automate the Downstream Data Mining Process with output from the Data Mining Xcelerator. Whereas the Data Mining Xcelerator can locate HTML pages containing text links and descriptions of ALS biomarkers, it does not take the next step of going through each page to scan text for the intended data mining target, biomarker names, and extract them. That function can be automated by the Data Mining Xtractor, based on the steps outlined below.

The following output code generated by the URAQMD process, from Case Study Example 1 above will be used as input to the AI Data Refining Process component Data Mining Xtractor to data mine biomarkers at the surface Level.

https://www.ncbi.nlm.nih.gov/pubmed/?term=als+biomarker
https://www.google.com/search?q=als+biomarker
https://www.bing.com/search?q=als+biomarker
https://www.ask.com/web?q=als+biomarker
https://search.yahoo.com/search?p=als+biomarker
https://www.ncbi.nlm.nih.gov/pubmed/?term=alzheimers+biomarker
https://www.google.com/search?q=alzheimers+biomarker
https://www.bing.com/search?q=alzheimers+biomarker
https://www.ask.com/web?q=alzheimers+biomarker
https://search.yahoo.com/search?p=alzheimers+biomarker
https://www.ncbi.nlm.nih.gov/pubmed/?term=diabetes+biomarker
https://www.google.com/search?q=diabetes+biomarker
https://www.bing.com/search?q=diabetes+biomarker
https://www.ask.com/web?q=diabetes+biomarker
https://search.yahoo.com/search?p=diabetes+biomarker

Process for Mining Data from Data Mining Xcelerator Output

For each diseasetype (ALS, Alzheimer's and diabetes), data mine the search results which appear when the executable predefined queries output by the URAQMD process are executed to locate any biomarkers for each diseasetype and add those entries to a list of biomarkers by diseasetype with this data, to meet the requirements of SPEC04.

Before an artificial intelligence component can be devised to perform the final refining of output from the Data Mining Xcelerator process to retrieve the final target data, a set of rules would need to be devised. Under this component design, the sequence of tasks to be executed by the Data Mining Xtractor Process comprises the following tasks: 1) scan pages, 2) apply AI rules, 3) extract relevant target objects, and 4) add to output list.

AI Rules

AI-RULE-01 (Exact Phrase or Equivalent)

The first rule we can establish in analyzing the output data from the Data Mining Xcelerator is the formula “X is a biomarker for Y” where Y is the diseasetype. Then, review the output to locate similar phrases and mine the acronym strings.

Note: The results of the Data Mining Xtractor will allow us to specify values for X, so they can be fed back into the Data Mining Xcelerator to create executable predefined search queries for a Data Mining Dashboard Application, featuring biomarkers by diseasetype. Ideally, we are looking for a biomarker acronym for the X value.

AI-RULE-02 (Triangulation Frequency)

The second rule we can establish in analyzing the data is the formula where a particular biomarker or biomarker acronym appears multiple times through multiple search sources, the quantity, or triangulated frequency factor, is another important aspect to look at. It should also be stated that quality or authoritativeness of the source must also be considered an essential factor.

AI-RULE-03 (Drill Down Criteria)

The third rule which we can establish is the drill-down rule. In cases where a comprehensive overview of the subject is indicated in the subject line at the surface level, force a drill-down to mine data below the surface level.

Output

After applying these AI rules, the following data is the final resulting output of target objects from data mined by the Data Mining Xcelerator after AI processing by the Data Mining Xtractor, a Downstream data mining process. X values may now be assigned and fed back into the Data Mining Xcelerator to create a Data Mining Dashboard application.

Below is the Data Mining Xtractor output generated by applying AI-Rule-01, AI-Rule-02, and AI-Rule-03 to extract biomarkers for the respective diseasetype from output generated by Data Mining Xcelerator:
als.biomarkertype(“c9FTD”,“C9orf72”,“LRP4”, “MicroRNA-206”,“NFL+Neurofilament+Light+Chain”,“NP001”,“p75+p75ECD”,“pNfH”,“poly(GP)+protein”,“TDP-43”,“TGF-β”)”;
alzheimers.biomarkertype(“Aβ142+Beta+Amyloid(142)”,“Neurogranin”, “Phosphorylated-tau-181”,“RNA+BACE1”,“Total-tau”,“YKL-40”);
diabetes.biomarkertype(“hepatic+ELF+CK18”,“HbAlc”,“microRNA-15a”,“miR25-3p”,“miR378e”,“RBP4”,“TXNIP+gene”);

Once the biomarker acronyms have been extracted from the Data Mining Xtractor process, output can be to a text file (e.g., in CSV format), or those values can be used as input into the Data Mining Xcelerator to create predefined search queries for each biomarker linked to a Data Mining Dashboard application featuring information on biomarkers by diseasetype.

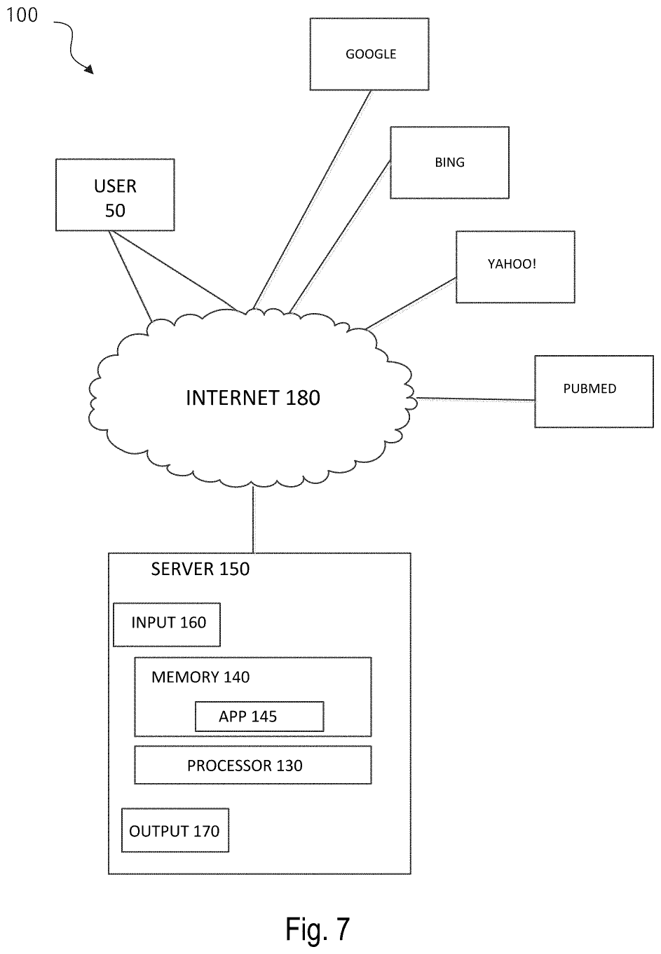

FIG. 7 is a diagram showing a system 100 for searching information across multiple data sources, according to an embodiment. As shown the system 100 includes a user 50 and a computing device 150, linked via Internet 180. Although only one user 50 is depicted, it is to be understood that many such users can be linked via the Internet 180 to the server 150. The user 50 also has a computing device such as a desktop computer, a laptop, a tablet, or a smartphone capable of interacting with the server 150. For instance, the computing device of the user 50 may be equipped with a suitable browser or have installed an “app” capable of interacting with the server 150. The computing device 150 includes a processor 130, memory 140, input device 160, and output device 170. The memory 140 further includes app 145 which includes computer program code embedded thereon capable of instructing the processor 130 when executed. The app 145 can include computer code (object code) for an implementation of the URAQMD to create the various query links discussed above. For example, the input device 160 can receive a set of search terms (which may be received as manual input, a text file, or from a downstream process). Additionally, the app 145 can include computer code (object code) for implementations of Upstream and Downstream processes, such as the Data Mining Dashboard, Data Mining Xcelerator, and the Data Mining XLoader. The output device 170 can output information (e.g., query links, a GUI interface for the Dashboard, etc.).

The system 100 can include a distributed application which is partitioned between a service provider (computing device 150) and a plurality of service requesters (e.g., computing device of user 50). Under this arrangement, a request-response protocol, such as hypertext protocol (HTTP), can be employed such that a client can initiate requests for services from the server 150, and the server 150 can respond to each respective request by, for example, executing an application (app 145), and (where appropriate) sending results to the client (e.g., computing device of user 50). It is to be understood that in some embodiments, however, substantial portions of the application logic may be performed on the client using, for example, the AJAX (Asynchronous JavaScript and XML) paradigm to create an asynchronous web application. Furthermore, it is to be understood that in some embodiments the application can be distributed among a plurality of different servers (not shown).

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for constructing a query link, comprising:
an input device that receives a set of search terms; and
a processor that constructs at least one query link using the search terms;
wherein the constructed query link is a hypertext link.

2. The system of claim 1, wherein the hypertext link is a URL.

3. The system of claim 2, wherein the URL includes a set of keywords.

4. The system of claim 3, wherein the set of keywords includes the search terms.

5. The system of claim 2, wherein the URL is the address of a search engine.

6. The system of claim 5, wherein the search engine is configured to search information from the Internet.

7. The system of claim 5, wherein the search engine is configured to search a database.

8. The system of claim 5, wherein further comprising a GUI adapted to execute the URL responsive to a one-click user selection.

9. The system of claim 8, wherein the one-click selection includes selection of a button.

10. The system of claim 9, wherein the GUI includes a label specifying the information to be retrieved.

11. The system of claim 10, wherein the label further specifies the data source.

12. The system of claim 9, wherein the GUI includes a plurality of buttons, each of the buttons associated with a query link.

13. The system of claim 1, wherein the processor effects the query link to be executed and returns a result set related to the search terms.

14. The system of claim 13, wherein the returned result set is data mined from a larger result set obtained from a search engine.

15. The system of claim 14, wherein the data mining includes applying artificial intelligence.

16. The system of claim 1, wherein the search terms are input using one of a form or a file.

17. A method for constructing a query link, comprising:
obtaining a set of search terms; and
constructing at least one query using the search terms, wherein the query is a hypertext link.

18. The method of claim 17, wherein the hypertext link is a URL that includes at least some of the search terms.

19. The method of claim 18, wherein the URL is the address of a search engine.

20. The method of claim 18, further comprising executing the at least one query responsive to a one-click selection.
